(19) United States
(12) Patent Application Publication
(10) Pub. No.: US 2018/0349529 A1
(43) Pub. Date: Dec. 6, 2018

(54) Systems And Methods Of Numerically Simulating Structural Behaviors Using FONVL Finite Elements

(71) Applicant: Livermore Software Technology Corporation, Livermore, CA (US)

(72) Inventor: Zhidong Han, Livermore, CA (US)

(21) Appl. No.: 15/610,720

(22) Filed: Jun. 1, 2017

(51) Int. Cl. G06F 17/50; G06F 17/11

(52) U.S. Cl. CPC G06F 17/5018; G06F 2217/16; G06F 17/11

(57) ABSTRACT

Methods and systems for numerically simulating structural behaviors of a product are disclosed. FEA model representing a product is received in a computer system. FEA model contains nodal points connected by first order non-“volumetric-locking” (FONVL) finite elements. Each FONVL finite element is configured with volumetric DOFs at respective boundaries. Numerically-simulated structural behaviors of the product are obtained by conducting a time-marching simulation using the FEA model. At each solution cycle of the simulation for each FONVL finite element, calculating volumetric variations at the respective boundaries based on corresponding one of the volumetric DOFs; and then solving unknown coefficients of a linear formula that defines each FONVL finite element's volumetric strain distribution using the calculated volumetric variations along with representative coordinates of the respective boundaries.

### FIELD

The invention generally relates to methods, systems and software product used in the area of computer-aided engineering analysis, more particularly to methods and systems used in obtaining numerically simulated structural behaviors of a product modeled with first order non-“volumetric-locking” (FONVL) finite elements.

### BACKGROUND

With advance of computer technology, computer aided engineering (CAE) and computer aided design (CAD) have been used for helping engineers/scientists to design products in various industries (e.g., automotive, aerospace, etc.). One of the first developed CAE technologies is finite element analysis (FEA), which is a computerized method widely used in industry to model and solve engineering problems relating to complex systems such as three-dimensional non-linear structural design and analysis. FEA derives its name from the manner in which the geometry of the object under consideration is specified.

The FEA software is provided with a model of the geometric description and the associated material properties at each point within the model (sometimes referred to as a FEA mesh model). In this model, the geometry of the system under analysis is represented by solids, shells and beams of various sizes, which are referred to as finite elements. The vertices of the finite elements are referred to as nodes. The model is comprised of a finite number of finite elements, which are assigned a material name to associate with material properties. The model thus represents the physical space occupied by the object under analysis along with its immediate surroundings. The FEA software then refers to a table in which the properties (e.g., stress-strain constitutive equation, Young's modulus, Poisson's ratio, thermo-conductivity) of each material type are tabulated. Additionally, the conditions at the boundary of the object (i.e., loadings, physical constraints, etc.) are specified. In this fashion a model of the object and its environment is created.

In CAD, the outer surface of a physical object/product is represented by a three-dimensional wire frame of a number of connected triangles (i.e., polygons). To represent the entire volume of the physical object, tetrahedrons are generated from the surface model. Traditionally, the model automatically generated by CAD cannot be used for FEA due to several problems. For example, with the use of the piecewise linear shape function, the traditional triangular and tetrahedral elements are computationally efficient with one Gauss integration point. This linear shape function is also desirable for most contact algorithms. However, the well-known volumetric locking problem limits the use of these simple elements for general FEA stress analysis. FIG. 1 shows a typical volumetric locking problem of a linear triangular finite element 102. The element 102 defined by three nodes 111, 112 and 113 under a vertical point load F 120 pushing down at node 111. Node 112 and 113 are fixed. Due to the linear shape functions of the element 102, edges 121, 122 and 123 are straight. Only horizontal movements of node 111 are allowed if the material is nearly incompressible (e.g., Poisson's ratio approaches 0.5). As a result, the supposedly deformed element 102 does not deform at all (shown in the bottom diagram of FIG. 1). This realistic simulation results are referred to as volumetric locking. For those having ordinary skill in the art of finite element analysis would know that the volumetric locking problem can be similarly shown in a linear tetrahedral finite element in three dimensional space.

To solve the volumetric locking problem, one prior art approach uses higher order elements. However, this may be used in static stress analysis. Non-linear shape function would cause a time-step issue in dynamic analysis using explicit solver. Contact algorithm would also become very costly due to curved contact surfaces.

Another prior art approach uses cubic bubble functions as shape functions. However, this would cause other shortcomings such as losing Kronecker delta property in shape functions, thereby defeating the purpose of using FEA.

It would therefore be desirable to have improved methods and systems for numerically simulating structural behaviors of a product modeled with finite elements without volumetric locking.

### SUMMARY

This section is for the purpose of summarizing some aspects of the present application and to briefly introduce embodiments. Simplifications or omissions in this section as well as in the abstract and the title herein may be made to avoid obscuring the purpose of the section. Such simplifications or omissions are not intended to limit the scope of the present application.

Systems and methods for numerically simulating structural behaviors of a product modeled with first order non-“volumetric-locking” (FONVL) finite elements are disclosed. According to one aspect, a computerized model (e.g., FEA model) representing a product is received in a computer system having a FEA application module installed thereon. FEA model contains nodal points connected by FONVL finite elements. Each FONVL finite element is configured with volumetric DOFs at respective boundaries. The volumetric DOFs are configured such that (a) shape functions of each FONVL finite element stay the same, and (b) shear stresses of each FONVL finite element stay constant.

Numerically-simulated structural behaviors of the product are then obtained by conducting a time-marching simulation using the FEA model. Time-marching simulation covers a time duration in a number of solution cycles. At each solution cycle for each FONVL finite element, calculating volumetric variations at the respective boundaries based on corresponding one of the volumetric DOFs; and then solving unknown coefficients of a linear formula that defines said each FONVL finite element's volumetric strain distribution using the calculated volumetric variations along with representative coordinates of the respective boundaries.

Objects, features, and advantages of the invention will become apparent upon examining the following detailed description of an embodiment thereof, taken in conjunction with the attached drawings.

### BRIEF DESCRIPTION OF THE DRAWINGS

These and other features, aspects, and advantages of the invention will be better understood with regard to the following description, appended claims, and accompanying drawings as follows:

FIG. 1 is a diagram showing an example for demonstrating volumetric locking problem in first order triangular finite elements;

FIG. 2 is a flowchart illustrating an example process of numerically simulating structural behaviors of a product modeled with FONVL finite elements, according to one embodiment of the invention;

FIG. 3A is a diagram depicting an example two-dimensional FONVL finite element with volumetric DOFs at respective boundary centroids in accordance with one embodiment of the invention;

FIG. 3B is a diagram showing an example shape function of the two-dimensional FONVL finite element of FIG. 3A.

FIG. 3C is a diagram showing example nodal displacements of the two-dimensional FONVL finite element of FIG. 3A.

FIGS. 3D-3E are diagrams showing examples of volumetric variation of the two-dimensional FONVL finite element of FIG. 3A with respective to one of the volumetric DOFs in accordance with one embodiment of the invention;

FIG. 4A is a diagram depicting an example three-dimensional FONVL finite element with volumetric DOFs at respective boundary centroids in accordance with one embodiment of the invention;

FIGS. 4B-4E are diagrams showing four faces of the three-dimensional FONVL finite element of FIG. 4A.

FIG. 4F is a diagram showing an example of volumetric variation of the three-dimensional FONVL finite element of FIG. 4A with respective to one of the volumetric DOFs in accordance with one embodiment of the invention;

FIG. 5 is a diagram showing an example pyramid structure for comparing numerically-simulated structural behaviors using first order tetrahedral element and using FONVL finite element in accordance with one embodiment of the invention; and

FIG. 6 is a function block diagram showing salient components of an exemplary computer system, in which one embodiment of the invention may be implemented.

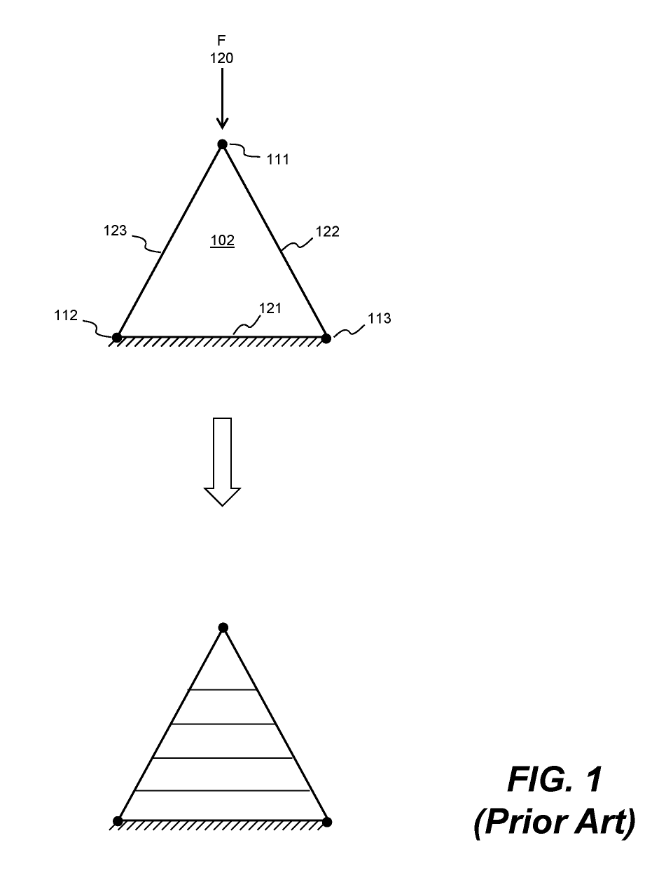

### DETAILED DESCRIPTION OF EMBODIMENTS

In the following description, numerous specific details are set forth in order to provide a thorough understanding of embodiments of the invention. However, it will become obvious to those skilled in the art that the invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

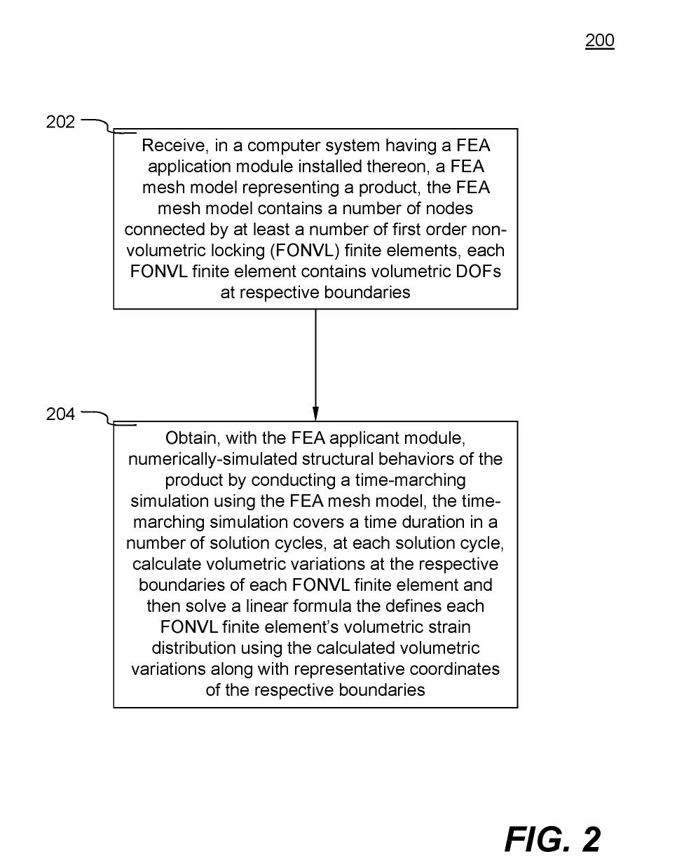

Embodiments of the invention are discussed herein with reference to FIGS. 2-6. However, those skilled in the art will readily appreciate that the detailed description given herein with respect to these figures is for explanatory purposes as the invention extends beyond these limited embodiments.

Referring first to FIG. 2, it is shown a flowchart illustrating an example process 200 of numerically simulating structural behaviors of a product in response to a loading using first order non-“volumetric-locking” (FONVL) finite elements in accordance with an embodiment of the invention. Process 200 is preferably implemented in software and understood with other figures in this document.

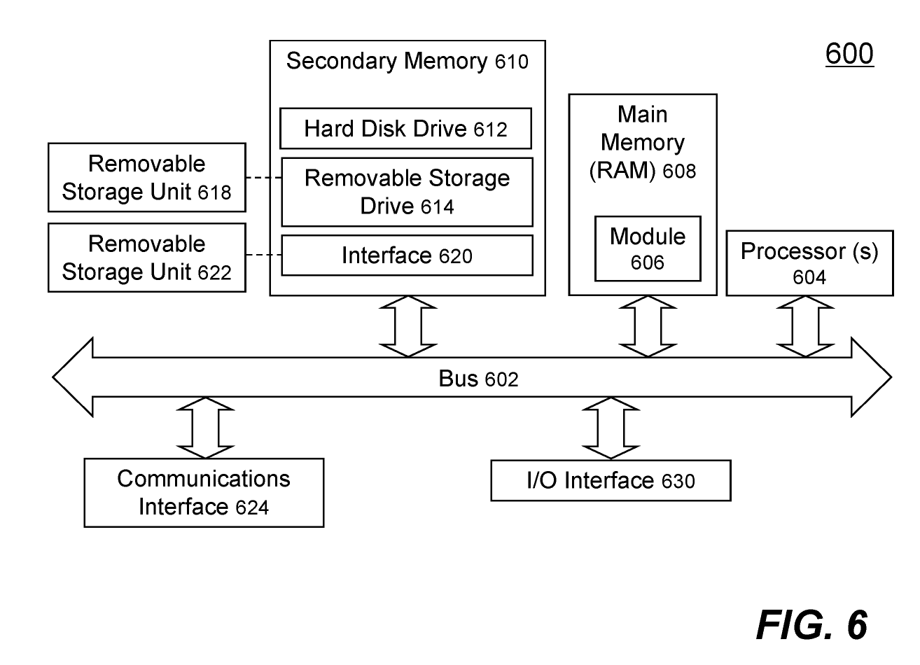

Process 200 starts at step 202 by receiving a computerized model (e.g., finite element analysis (FEA) mesh model) representing a product in a computer system (e.g., computer system 600 shown in FIG. 6) having an application module (e.g., FEA application module) installed thereon. FEA mesh model contains a number of nodal points connected by at least a number of FONVL finite elements. Each FONVL finite element contains volumetric degrees-of-freedom (DOFs) at respective boundaries. For example, respective centers or centroids of the boundaries may be selected for the locations of the volumetric DOFs.

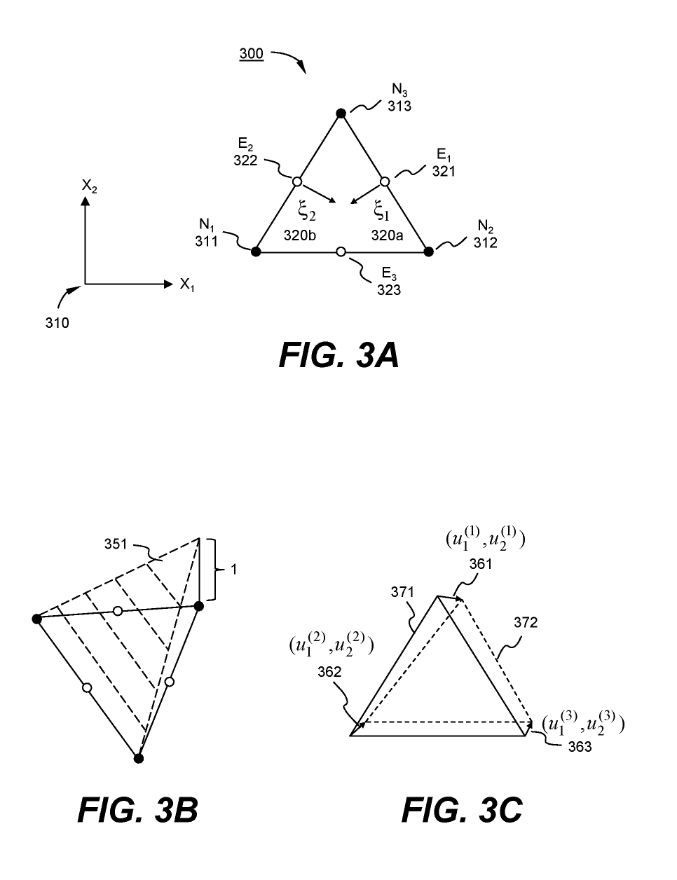

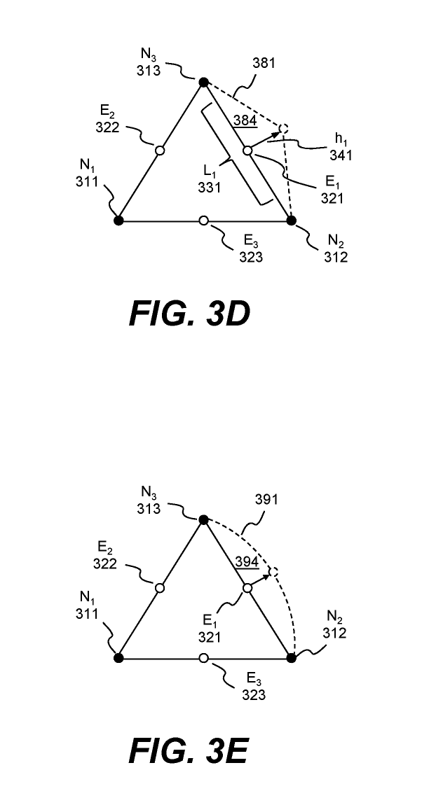

FIG. 3A is a diagram showing an example two-dimensional (2-D) FONVL finite element 300, which is a first order triangular element with volumetric DOFs at respective boundary's centers (E₁ 321, E₂ 322 and E₃ 323). Two-dimensional FONVL finite element 300 has three vertices or corner nodes (i.e., N₁ 311, N₂ 312 and N₃ 313). A global coordinate system (X₁-X₂) 310 and an element parameter system (ξ₁-ξ₂) 320a-320b are shown in FIG. 3A.

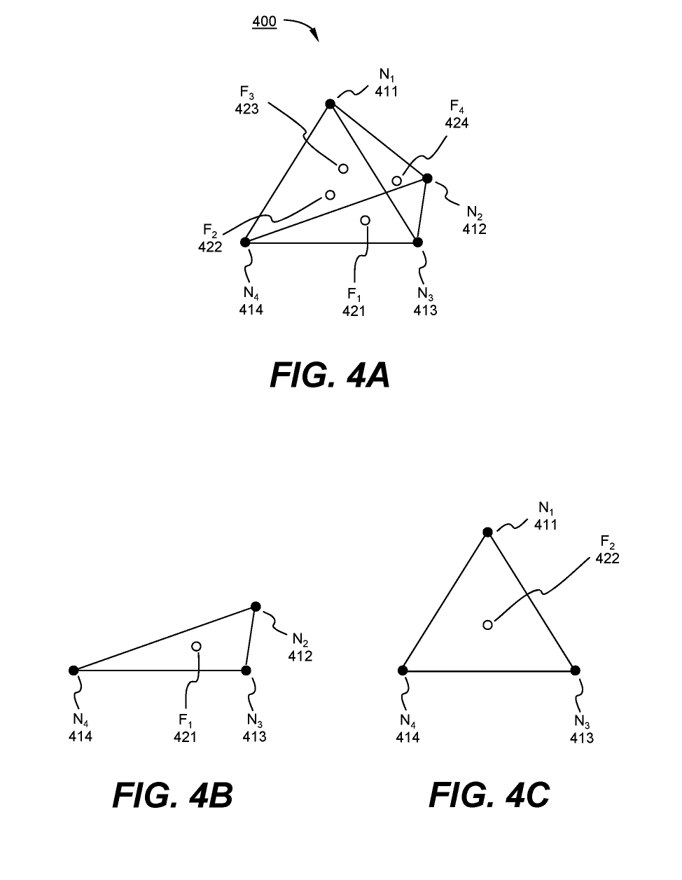

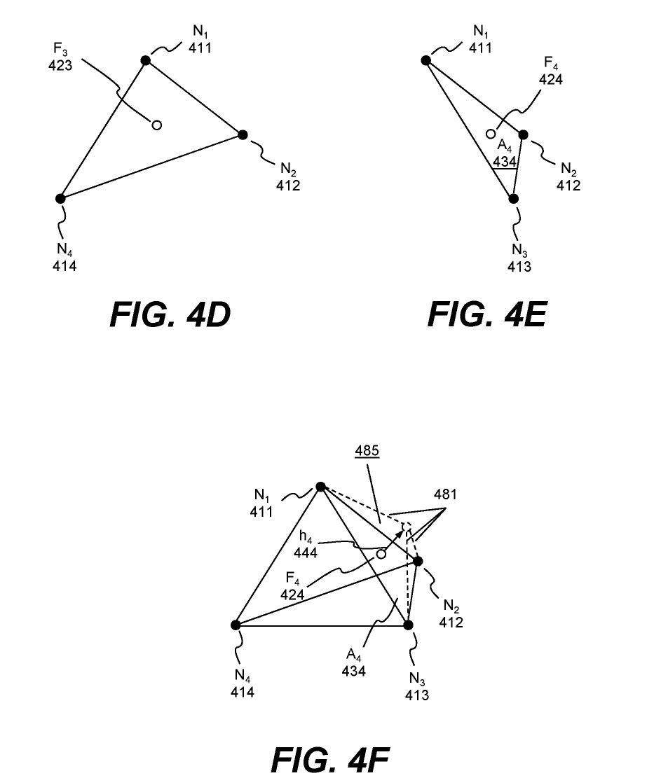

FIG. 4A is a diagram showing an example three-dimensional (3-D) FONVL finite element 400, which is a first order tetrahedral element with volumetric DOFs at respective boundary's centroids (F₁ 421, F₂ 422, F₃ 423 and F₄ 424). Three-dimensional FONVL finite element 400 has four vertices or corner nodes (i.e., N₁ 411, N₂ 412, N₃ 413 and N₄ 414). To better clarify the three-dimensional figure shown in FIG. 4A, four two-dimensional triangular faces (i.e., boundary) of the three-dimensional FONVL finite element 400 (i.e., tetrahedron) are shown in FIGS. 4B-4E. For illustration simplicity, either global coordinate system or element coordinate system is not shown in FIG. 4A. For those having ordinary skill in the art, these coordinate systems are well known in field of finite element analysis.

The following equations are for the two-dimensional and three-dimensional FONVL finite elements:

For a 2D FONVL finite element, the linear shape functions are defined as:

N⁽¹⁾=ξ₁

N⁽²⁾=ξ₂ (1)

N⁽³⁾=1−ξ₁−ξ₂

For a 3D FONVL finite element, the linear shape functions are defined as:

N⁽¹⁾=ξ₁

N⁽²⁾=ξ₂ (2)

N⁽³⁾=ξ₃

N⁽⁴⁾=1−ξ₁ξ₂−ξ₃

where (ξ₁, ξ₂) and (ξ₁, ξ₂, ξ₃) are the 2D and 3D FONVL finite element parameters, respectively. An example shape function 351 for a 2D FONVL finite element is shown in FIG. 3B. The example shape function 351 possesses a value of unity (1) at one node and zero at other nodes.

The Jacobian for the 2-D FONVL finite element is as follows:

$${J}_{ij} = \frac{\partial {x}_{i}}{\partial {ξ}_{j}} {J}_{kj}^{- 1} ≡ {\sum }_{n = 1}^{3} \frac{\partial {N}^{( n )}}{\partial {ξ}_{j}} {x}_{i}^{( n )} , i and j = 1 , 2 \qquad ( 3 )$$

The Jacobian for the 3-D FONVL finite element is computed as follows:

$${J}_{ij} = \frac{\partial {x}_{i}}{\partial {ξ}_{j}} ≡ {\sum }_{n = 1}^{4} \frac{\partial {N}^{( n )}}{\partial {ξ}_{j}} {x}_{i}^{( n )} , i and j = 1 , 3 \qquad ( 4 )$$

where xᵢ⁽ⁿ⁾ are the nodal coordinates in a global coordinate system (e.g., global coordinate system 310 of FIG. 3A).

The strains of 2-D FONVL finite element are computed as follows:

$${ɛ}_{ij} = \frac{\partial {u}_{i}}{\partial {ξ}_{k}} {J}_{kj}^{- 1} ≡ {\sum }_{n = 1}^{3} \frac{\partial {N}^{( n )}}{\partial {ξ}_{k}} {u}_{i}^{( n )} {J}_{kj}^{- 1} , i , j and k = 1 , 2 \qquad ( 5 )$$

The strains of 3-D FONVL finite element are computed as follows:

$${ɛ}_{ij} = \frac{\partial {u}_{i}}{\partial {ξ}_{k}} {J}_{kj}^{- 1} ≡ {\sum }_{n = 1}^{4} \frac{\partial {N}^{( n )}}{\partial {ξ}_{k}} {u}_{i}^{( n )} {J}_{kj}^{- 1} , i , j and k = 1 , 3 \qquad ( 6 )$$

where uᵢ⁽ⁿ⁾ are the nodal displacements in a global coordinate system. FIG. 3C shows) the definitions of three nodal displacements: (u₁⁽¹⁾, u₂⁽¹⁾) 361, (u₁⁽²⁾, u₂⁽²⁾) 362 and (u₁⁽³⁾, u₂⁽³⁾) 363 at three nodes from the undeformed 2D FONVL finite element 371 (solid line triangle) to a deformed finite element 372 (broken line triangle).

Using Equations (5) and (6), average volumetric strain for 2D FONVL finite element is defined as:

$${ɛ}^{avol} = {\sum }_{k = 1}^{2} {ɛ}_{kk} \qquad ( 7 )$$

Average volumetric strain for 3D FONVL finite element is defined as:

$${ɛ}^{avol} = {\sum }_{k = 1}^{3} {ɛ}_{kk} \qquad ( 8 )$$

Pure shear strains for 2D FONVL finite element are computed as:

$${ɛ}_{ij}^{shear} = {ɛ}_{ij} - \frac{{ɛ}^{avol}}{2} {δ}_{ij} \qquad ( 9 )$$

where i and j=1, 2 are indices for dimensions (i.e., 2 for 2D).

Pure shear strains for 3D FONVL finite element are computed as:

$${ɛ}_{ij}^{shear} = {ɛ}_{ij} - \frac{{ɛ}^{avol}}{3} {δ}_{ij} \qquad ( 10 )$$

where i and j=1, 3 are indices for dimensions (i.e., 3 for 3D) and δ_{if} is the Kronecker delta tensor.

Referring back to process 200, at step 204, numerically-simulated structural behaviors of the product in response to a loading are obtained by conducting a time-marching simulation (i.e., time-domain non-linear structural dynamic analysis based on FEA) using the FEA mesh model. The time-marching simulation covers a time duration in a number of solution cycles or time steps. At each solution cycle for each FONVL finite element, volumetric variations at the respective boundaries are calculated based on the value of corresponding volumetric DOF. Unknown coefficients of a linear formula that defines said each FONVL finite element's volumetric strain distribution are then solved using the calculated volumetric variations along with representative coordinates of the respective boundaries (e.g., at centroids of the boundaries).

The linear formula for volumetric strain distribution is as follows:

$$\begin{matrix}{ɛ}^{vol} = {a}_{0} + {\sum }_{i = 1}^{2} {a}_{i} {x}_{i} for 2 D FONVL finite element & ( 11 ) \\ {ɛ}^{vol} = {a}_{0} + {\sum }_{i = 1}^{3} {a}_{i} {x}_{i} for 3 D FONVL finite element & ( 12 )\end{matrix}$$

where α₀ and αᵢ are unknown coefficients. For a 2D FONVL finite element, there are three unknown coefficients and three volumetric DOFs. For 3D FONVL finite element, there are four unknown coefficients and four volumetric DOFs.

In order to solve unknown coefficients in the linear formula, the same number of independent equations needs to be established. One method is to determine the volumetric strain at each of the volumetric DOFs.

For 2D FONVL finite element, the volumetric strain at each of the volumetric DOFs is

$${ɛ}_{( m )}^{vol} = {ɛ}^{avol} + \frac{Δ {V}^{( m )}}{{V}_{0}} , m = 1 , 3 \qquad ( 13 )$$

where V₀ is the original area of the 2D FONVL finite element, ΔV^{(m)} is the volumetric variation at one of the boundaries with respect to corresponding volumetric DOF.

For 3D FONVL finite element, the volumetric strain at each of the volumetric DOFs is

$${ɛ}_{( m )}^{vol} = {ɛ}^{avol} + \frac{Δ {V}^{( m )}}{{V}_{0}} , m = 1 , 4 \qquad ( 14 )$$

where V₀ is the original volume of the 3D FONVL finite element, ΔV^{(m)} is the volumetric variation at one of the boundaries with respect to corresponding volumetric DOF.

FIG. 3D is a diagram showing a first example volumetric variation of the two-dimensional FONVL finite element 300 of FIG. 3A. The first example volumetric variation at a boundary (i.e., the edge E₁ 321 between nodes N₂ 312 and N₃ 313) is a function of the length of the boundary (L₁ 331) and the value of volumetric DOF (h₁ 341) at the edge or boundary (E₁ 321).

The volumetric variation at one of the boundaries with respect to corresponding volumetric DOF in a 2D FONVL finite element is calculated as follows:

ΔV^{(m)}=½L₍ₘ₎h₍ₘ₎, m=1,3 (15)

where L₍ₘ₎ is the length of the boundary and h₍ₘ₎ is the value of the corresponding volumetric DOF. In other words, the first example volumetric variation shown in FIG. 3D is the area 384 between dotted line 381 and the boundary (i.e., the edge E₁ 321).

In another embodiment, the second example volumetric variation shown in FIG. 3E is the area 394 between dotted line 391 and the boundary (i.e., the edge E₁ 321 between nodes N₂ 312 and N₃ 313). Volumetric variations at other boundaries (edges) are similar to the examples shown in FIGS. 3D and 3E.

FIG. 4F is a diagram showing an example volumetric variation of the 3-D FONVL finite element 400 of FIG. 4A. The example volumetric variation at a boundary (i.e., the face F₄ 424 among nodes N₁ 411, N₂ 412 and N₃ 413) is a function of the area of the boundary (A₄ 434) and the value of corresponding volumetric DOF (h₄ 444) of the boundary (F₄ 424). In other words, the example volumetric variation shown in FIG. 4F is the volume 485 between dotted line surface 481 and the boundary (i.e., the face F₄ 424).

The volumetric variation at one of the boundaries corresponding to the volumetric DOF in a 3D FONVL finite element is calculated as follows:

ΔV^{(m)}=⅓A₍ₘ₎h₍ₘ₎, m=1,4 (16)

where A₍ₘ₎ is the area of the face or boundary and h₍ₘ₎ is the value of the corresponding volumetric DOF.

Other schemes for calculating volumetric variations may be used in 3D FONVL finite element similar to the one shown in FIG. 3E for 2D FONVL finite element. None of the other schemes for 3D FONVL finite element is shown; however for those having ordinary skill in the art would understand such schemes. For example, a curved surface can be formed among any three corner nodes. The volume between the curved surface and the original face is the volumetric variation. Finally, the illustrated example volumetric variations are positive (i.e., volume expansion or increase). The volumetric variation can also be negative (i.e., volume shrinkage or decrease (not shown).

Since the linear formula contains the same number of unknown coefficients as the number of volumetric DOFs in each FONVL finite element, hence the solution can be found by forming a set of simultaneous independent equations at centroids of the boundaries (i.e., edges for 2D and faces for 3D FONVL finite element). The set of simultaneous equation uses corresponding coordinates of the centroids along with the volumetric strain values calculated in Equation (13) or Equation (14) for 2D FONVL finite element or 3D FONVL finite element.

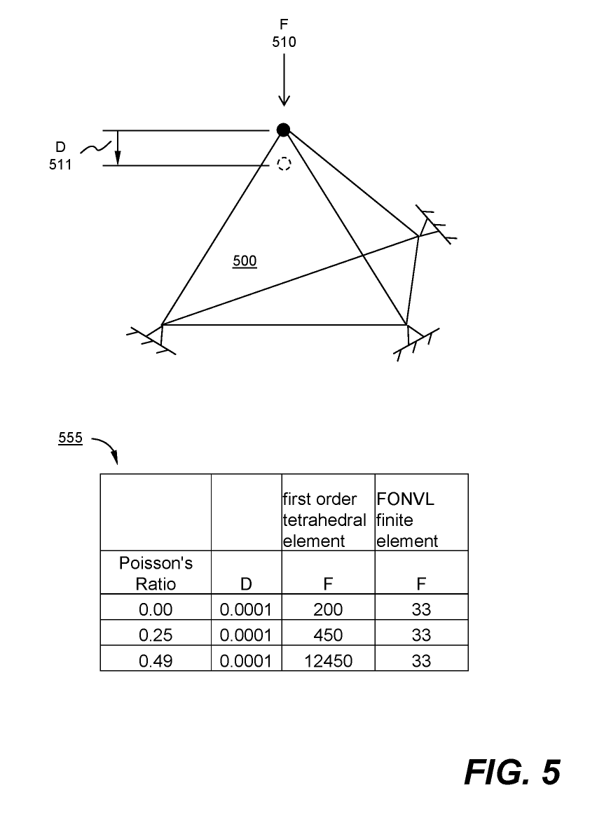

FIG. 5 is a diagram showing an example pyramid structure for comparing numerically-simulated structural behaviors using first order tetrahedral element and using FONVL finite element. The pyramid 500 is modeled with a single element with three nodes at the bottom fixed, only the top node is allowed to move. First, a first order tetrahedral element is used. Then a 3D FONVL finite element is used. Various Poisson's ratios are modeled. A vertical load F 510 is applied to the model to produce a displacement D 511 (vertical drop due to the force F). Table 555 shown in FIG. 5 lists the results for comparison. As Poisson's ratio approaching 0.5, the force F 510 required to produce the same displacement D 511 increases drastically in the model using first order tetrahedral element. This clearly demonstrates the volumetric locking behaviors. In contrast, the force F 510 stays as a constant value in the model using FONVL finite element.

An embodiment of the invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals which may be electronic, electromagnetic, optical, or other signals capable of being received by communications interface 624. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium”, “computer usable medium”, and “computer readable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/O) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the invention as discussed herein. In particular, the computer programs, when executed, enable the processor 604 to perform features of the invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/O interface 630 to achieve desired tasks. In operation, when at least one processor 604 executes one of the application modules 606, the results are computed and stored in the secondary memory 610 (i.e., hard disk drive 612). The status of the computer simulation (e.g., finite element analysis results) is reported to the user via the I/O interface 630 in either text or graphical representation.

Although the invention has been described with reference to specific embodiments thereof, these embodiments are merely illustrative, and not restrictive of, the invention. Various modifications or changes to the specifically disclosed exemplary embodiments will be suggested to persons skilled in the art. For example, whereas most of the figures in this document are for 2D FONVL finite element for illustration clarity and simplicity, the invention is also for 3D FONVL finite element. Furthermore, term “volumetric variation” has been used and shown throughout this document. “Volumetric variation” is actually area difference in a 2D FONVL finite element while “volumetric variation” is volume difference in a 3D FONVL finite element. Finally, term “boundary” or “boundaries” have been used and shown throughout. “Boundary” or “boundaries” are referred to as edge(s) in a 2D FONVL finite element and referred to as face(s) in a 3D FONVL finite element. In summary, the scope of the invention should not be restricted to the specific exemplary embodiments disclosed herein, and all modifications that are readily suggested to those of ordinary skill in the art should be included within the spirit and purview of this application and scope of the appended claims.

I claim:

1. A method of numerically simulating structural behaviors of a product in response to a loading, the method comprising:
receiving, in a computer system having a finite element analysis (FEA) application module installed thereon, a FEA model representing a product, the FEA model containing a plurality of nodal points connected by at least a plurality of first order non-“volumetric-locking” (FONVL) finite elements, each FONVL finite element being configured with volumetric degrees-of-freedom (DOFs) at respective boundaries, the volumetric DOFs being configured such that:
(a) said each FONVL finite element's shape functions stay the same,
(b) said each FONVL finite element' shear stresses stay constant; and
obtaining numerically-simulated structural behaviors of the product in response to a loading by conducting a time-marching simulation using the FEA model with the FEA application module, the time-marching simulation covering a time duration in a plurality of solution cycles, at each solution cycle for said each FONVL finite element,
calculating volumetric variations at the respective boundaries based on corresponding one of the volumetric DOFs; and
solving unknown coefficients of a linear formula that defines said each FONVL finite element's volumetric strain distribution using the calculated volumetric variations along with representative coordinates of the respective boundaries.

2. The method of claim 1, wherein said FONVL finite elements are derived from three-dimensional tetrahedral elements.

3. The method of claim 1, wherein said FONVL finite elements are derived from two-dimensional triangular elements.

4. The method of claim 1, wherein said each of the volumetric DOFs is a scalar DOF shared by two adjacent FONVL finite elements and does not affect rigid body motion of the product.

5. The method of claim 1, wherein said each of the volumetric DOFs is co-rotational thereby no updating is required during rotation of said each FONVL finite element.

6. The method of claim 1, wherein said representative coordinates of the respective boundaries are coordinates of centroids of the respective boundaries.

7. The method of claim 1, wherein the linear formula contains an equal number of the unknown coefficients as the number of the volumetric DOFs in said each FONVL finite element.

8. A system for numerically simulating structural behaviors of a product in response to a loading, the system comprising:
an input/output (I/O) interface;
a memory for storing computer readable code for finite element analysis (FEA) application module;
at least one processor coupled to the memory, said at least one processor executing the computer readable code in the memory to cause said FEA application module to perform operations of:
receiving a FEA model representing a product, the FEA model containing a plurality of nodal points connected by at least a plurality of first order non-“volumetric-locking” (FONVL) finite elements, each FONVL finite element being configured with volumetric degrees-of-freedom (DOFs) at respective boundaries, the volumetric DOFs being configured such that:
(a) said each FONVL finite element's shape functions stay the same,
(b) said each FONVL finite element' shear stresses stay constant; and
obtaining numerically-simulated structural behaviors of the product in response to a loading by conducting a time-marching simulation using the FEA model, the time-marching simulation covering a time duration in a plurality of solution cycles, at each solution cycle for said each FONVL finite element,
calculating volumetric variations at the respective boundaries based on corresponding one of the volumetric DOFs; and
solving unknown coefficients of a linear formula that defines said each FONVL finite element's volumetric strain distribution using the calculated volumetric variations along with representative coordinates of the respective boundaries.

9. The system of claim 8, wherein said FONVL finite elements are derived from three-dimensional tetrahedral elements.

10. The system of claim 8, wherein said FONVL finite elements are derived from two-dimensional triangular elements.

11. The system of claim 8, wherein said each of the volumetric DOFs is a scalar DOF shared by two adjacent FONVL finite elements and does not affect rigid body motion of the product.

12. The system of claim 8, wherein said each of the volumetric DOFs is co-rotational thereby no updating is required during rotation of said each FONVL finite element.

13. The system of claim 8, wherein said representative coordinates of the respective boundaries are coordinates of centroids of the respective boundaries.

14. The system of claim 8, wherein the linear formula contains an equal number of the unknown coefficients as the number of the volumetric DOFs in said each FONVL finite element.

15. A non-transitory computer readable storage medium containing computer executable instructions for numerically simulating structural behaviors of a product in response to a loading by a method comprising:
receiving, in a computer system having a finite element analysis (FEA) application module installed thereon, a FEA model representing a product, the FEA model containing a plurality of nodal points connected by at least a plurality of first order non-“volumetric-locking” (FONVL) finite elements, each FONVL finite element being configured with volumetric degrees-of-freedom (DOFs) at respective boundaries, the volumetric DOFs being configured such that:
(a) said each FONVL finite element's shape functions stay the same,
(b) said each FONVL finite element' shear stresses stay constant; and
obtaining numerically-simulated structural behaviors of the product in response to a loading by conducting a time-marching simulation using the FEA model, the time-marching simulation covering a time duration in a plurality of solution cycles, at each solution cycle for said each FONVL finite element,
calculating volumetric variations at the respective boundaries based on corresponding one of the volumetric DOFs; and
solving unknown coefficients of a linear formula that defines said each FONVL finite element's volumetric strain distribution using the calculated volumetric variations along with representative coordinates of the respective boundaries.

16. The non-transitory computer readable storage medium of claim 15, wherein said FONVL finite elements are derived from three-dimensional tetrahedral elements.

17. The non-transitory computer readable storage medium of claim 15, wherein said FONVL finite elements are derived from two-dimensional triangular elements.

18. The non-transitory computer readable storage medium of claim 15, wherein said each of the volumetric DOFs is a scalar DOF shared by two adjacent FONVL finite elements and does not affect rigid body motion of the product.

19. The non-transitory computer readable storage medium of claim 15, wherein said representative coordinates of the respective boundaries are coordinates of centroids of the respective boundaries.

20. The non-transitory computer readable storage medium of claim 15, wherein the linear formula contains an equal number of the unknown coefficients as the number of the volumetric DOFs in said each FONVL finite element.
